(19) United States
(12) Patent Application Publication
(10) Pub. No.: US 2026/0316828 A1
(43) Pub. Date: Oct. 15, 2026

(54) Vehicle Control Apparatus, Vehicle Control Method, and Vehicle Control System

(71) Applicant: Hitachi Astemo, Ltd., Hitachinaka-shi, Ibaraki (JP)

(72) Inventors: Yuu SATO, Hitachinaka-shi, Ibaraki (JP); Hiroki SONODA, Hitachinaka-shi, Ibaraki (JP); Atsushi TAGUCHI, Hitachinaka-shi, Ibaraki (JP)

(21) Appl. No.: 19/109,281

(22) PCT Filed: Dec. 5, 2023
(86) PCT No.: PCT/JP2023/043396

§ 371 Date: Mar. 6, 2025

(30) Foreign Application Priority Data
Dec. 12, 2022 (JP) 2022-198164

(51) Int. Cl. B62D 9/00; B60W 10/16; B60W 10/18; B60W 30/045; B60W 30/18

(52) U.S. Cl. CPC B62D 9/005; B60W 10/16; B60W 10/18; B60W 30/045; B60W 30/18145; B60W 2510/20; B60W 2710/18; B60W 2720/266; B60W 2720/406

(57) ABSTRACT

The vehicle control apparatus is provided in a vehicle having a steer-by-wire system for steering the right and left steered road wheels which are mechanically separate from the steering wheel and of which the scrub radius is set to be negative. When a control unit included in the vehicle control apparatus acquires an abnormal signal of a steering function in the steer-by-wire system, the control unit outputs, based on a steering operation that is input to the steering wheel, a driving and braking command, between the right and left steered road wheels, a total value of a driving force and a braking force applied to a turning outer steered road wheel of the vehicle becomes less than a total value of a driving force and a braking force applied to a turning inner steered road wheel of the vehicle.

### TECHNICAL FIELD

The present invention relates to a vehicle control apparatus, to a vehicle control method, and to a vehicle control system that control a vehicle provided with a steer-by-wire system.

### BACKGROUND ART

With recent developments in automated-driving techniques, progress has been made in research and development relating to steer-by-wire (SbW) steering mechanisms. In by-wire techniques, it is important to ensure reliability, and therefore, system redundancy is used. However, such redundancy increases system cost. To solve this issue, for example, Patent Document 1 accomplishes a turning function by generating a vehicle yaw moment by allocating braking forces applied to the individual road wheels when the steering function of the SbW steering mechanism malfunctions.

### REFERENCE DOCUMENT LIST

### Patent Document

Patent Document 1: JP 2000-190863 A

### SUMMARY OF THE INVENTION

### Problem to be Solved by the Invention

However, when the steering function malfunctions, controlling the vehicle yaw moment alone cannot necessarily accomplish the target turn, in view of the impact of the tire steering caused by the braking forces and driving forces (driving and braking forces) and the alignment.

That is, if a braking force is applied to one of the front road wheels to accomplish a turn, the turning direction changes based on the setting of the individual kingpin offset. In the case of a vehicle of which the scrub radius is set to be negative, if a braking force is applied to the right front road wheel for a right turn, because the front road wheels turn to the left, the vehicle turns in the direction opposite to the target turning direction. That is, the tires are steered in the direction that prevents the turn based on the braking force. Similarly, if a braking force is applied to the left front road wheel for a left turn, the tires are also steered in the direction that prevents the turn based on the braking force.

The present invention has been made in view of the above-described circumstances, and an object of the present invention is to provide a vehicle control apparatus, a vehicle control method, and a vehicle control system that can accomplish a turning function including tire steering based on driving and braking forces.

### Means for Solving the Problem

In one aspect of the present invention, there are provided a vehicle control apparatus and a vehicle control method, the vehicle control apparatus being provided in a vehicle having a steer-by-wire system for steering right and left steered road wheels which are mechanically separate from a steering wheel and of which a scrub radius is set to be negative, wherein when a control unit included in the vehicle control apparatus acquires an abnormal signal of a steering function in the steer-by-wire system, the control unit outputs, based on a steering operation that is input to the steering wheel, a first driving and braking command, such that assuming that a driving force is a positive physical quantity and a braking force is a negative physical quantity, between the right and left steered road wheels, a total value of a driving force and a braking force applied to a turning outer steered road wheel of the vehicle becomes less than a total value of a driving force and a braking force applied to a turning inner steered road wheel of the vehicle.

In another aspect of the present invention, there is provided a vehicle control system including the vehicle control apparatus and a drive and brake actuator that applies driving and braking forces to the right and left steered road wheels based on the first driving and braking command that is output by the control unit.

### Effects of the Invention

The present invention accomplishes a turn based on driving and braking forces not only by generating a vehicle yaw moment by using the difference between the right and left driving and braking forces of a vehicle, but also by using tire steering based on the driving and braking forces applied to the individual road wheels and alignment. Thus, the present invention can provide a vehicle control apparatus, a vehicle control method, and a vehicle control system that can accomplish a turning function including tire steering based on the driving and braking forces.

### BRIEF DESCRIPTION OF THE DRAWINGS

FIG. 1 illustrates a configuration of a vehicle control apparatus and a vehicle control system according to a first embodiment of the present invention.

FIG. 2 is a flowchart schematically illustrating a vehicle control method used with the vehicle control apparatus and the vehicle control system illustrated in FIG. 1.

FIG. 3A illustrates a vehicle motion based on driving and braking forces during a turn.

FIG. 3B illustrates a tire motion based on driving and braking forces during a turn.

FIG. 4 illustrates a vehicle motion based on another control method using driving and braking forces.

FIG. 5 illustrates yet another control method using driving and braking forces, that is, a vehicle motion when a driving force applied to an individual road wheel can be controlled.

FIG. 6 illustrates a vehicle control apparatus, a vehicle control method, and a vehicle control system according to a second embodiment of the present invention, that is, a flowchart schematically illustrating a vehicle control method in which the tire angle is controlled, and the steering is assisted when the steer-by-wire system is normal.

FIG. 7 illustrates a vehicle motion based on control using driving and braking forces in the vehicle control method illustrated in FIG. 6.

### MODE FOR CARRYING OUT THE INVENTION

Hereinafter, embodiments of the present invention will be described with reference to the drawings.

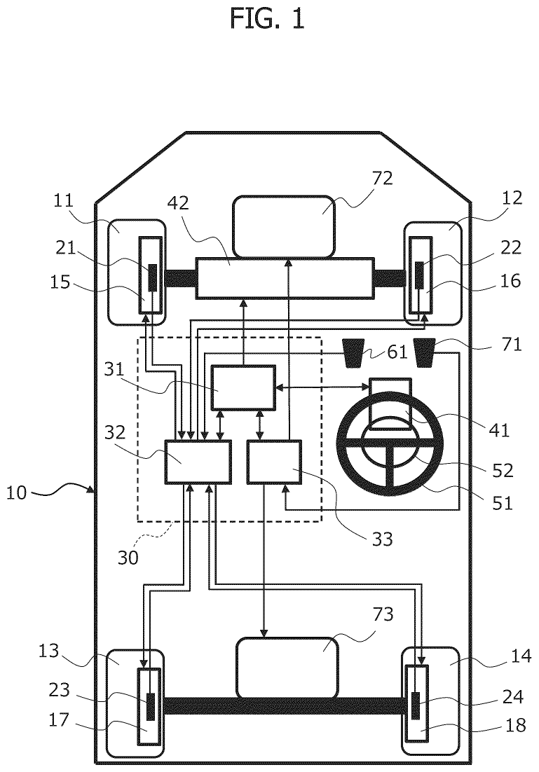

FIG. 1 illustrates a configuration of a vehicle control apparatus and a vehicle control system according to an embodiment of the present invention. A vehicle 10 includes a motor 72 that drives front road wheels (tires) 11 and 12, and a motor 73 that drives rear road wheels (tires) 13 and 14. Motors 72 and 73 function as drive actuators, and drive front road wheels 11 and 12 and rear road wheels 13 and 14, respectively, based on the operation amount of an accelerator pedal 71. The operation amount is input to a powertrain control unit 33.

In vehicle 10, a steering wheel 51 is not physically connected to front road wheels (steered road wheels) 11 and 12. In other words, a steer-by-wire steering mechanism (steer-by-wire system) in which steering wheel 51 and front road wheels 11 and 12 are mechanically separate from each other is mounted in vehicle 10. That is, unlike conventional steering mechanisms, this steering mechanism does not include a steering shaft.

When the driver operates steering wheel 51, a steering angle sensor 52 detects the steering angle, a steering control unit 31 calculates a target tire angle and a target reaction force based on the operating conditions. Next, steering control unit 31 executes steering control by outputting the target tire angle to a wheel actuator 42, and outputting the target reaction force to a reaction force actuator 41 such that a steering reaction torque is applied to steering wheel 51.

In addition, a brake control unit 32 executes deceleration by using brake actuators 15, 16, 17, and 18 based on the operation amount of a brake pedal 61 and the output from brake thrust sensors 21, 22, 23, and 24 that detect the thrust generated by the deceleration.

Steering control unit 31, brake control unit 32, and powertrain control unit 33 function as a control unit 30 of the vehicle control apparatus. Steering control unit 31 detects a system failure. If steering control unit 31 acquires an abnormal signal of the steering function, brake control unit 32 controls the braking forces applied by brake actuators 15, 16, 17, and 18, and powertrain control unit 33 controls the driving forces applied by motors 72 and 73, based on the steering operation that is input to steering wheel 51.

Next, brake control unit 32 selectively outputs a braking command to brake actuators 15, 16, 17, and 18, and powertrain control unit 33 selectively outputs a driving command to motors 72 and 73 such that, between the right and left steered road wheels, the total value of the driving force and braking force applied to the turning outer steered road wheel of vehicle 10 becomes less than the total value of the driving force and braking force applied to the turning inner steered road wheel of vehicle 10.

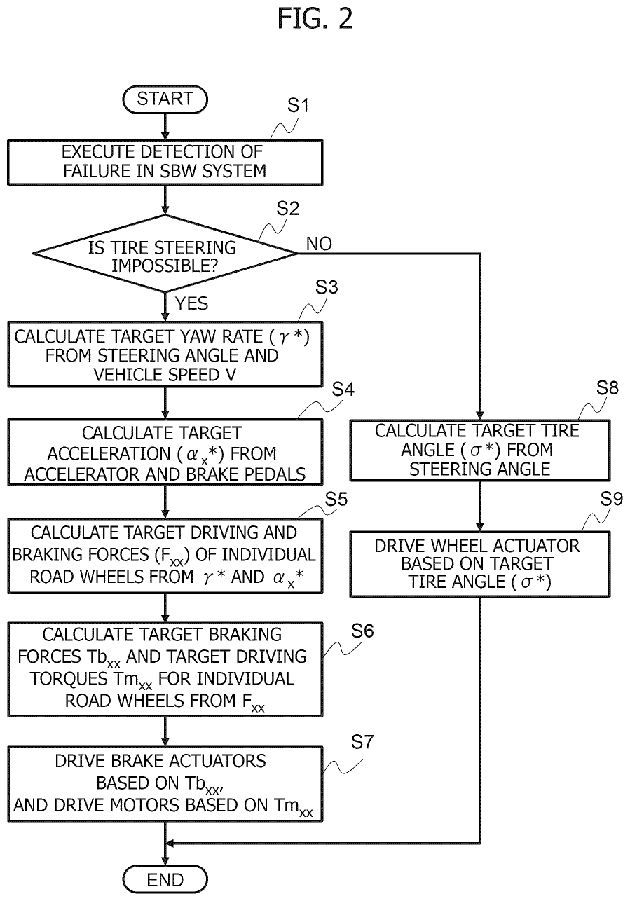

FIG. 2 is a flowchart schematically illustrating a vehicle control method used with the vehicle control apparatus illustrated in FIG. 1. When the ignition of vehicle 10 is turned ON, steering control unit 31 executes detection of a failure in the SbW system (step S1). Steering control unit 31 determines whether a failure that makes tire steering impossible has occurred (step S2). If such a failure has occurred, steering control unit 31 calculates a target yaw rate (γ*) from the steering angle detected by steering angle sensor 52 and a vehicle speed (V) (step S3). Next, brake control unit 32 detects the operation amount of brake pedal 61, powertrain control unit 33 detects the operation amount of accelerator pedal 71, and steering control unit 31 calculates a target longitudinal acceleration (αₓ*) (step S4).

Next, steering control unit 31 calculates target driving and braking forces (F_{fl}, F_{fr}, Fᵣₗ, and Fᵣᵣ) of the individual road wheels from target yaw rate (γ*) and target longitudinal acceleration (αₓ*) (step S5). Hereinafter, unless otherwise specified, the target driving and braking forces of the individual road wheels will be collectively referred to as “Fₓₓ”.

Next, in step S6, steering control unit 31 calculates target braking forces (Tbₓₓ) generated by brake actuators 15, 16, 17, and 18, and target driving torques (Tmₓₓ) generated by motors 72 and 73, from target driving and braking forces (Fₓₓ) of the individual road wheels.

Next, in step S7, brake control unit 32 drives brake actuators 15, 16, 17, and 18 based on target braking forces (Tbₓₓ), and powertrain control unit 33 drives motors 72 and 73 based on target driving torques (Tmₓₓ). Next, the process proceeds to END.

On the other hand, if steering control unit 31 determines that a failure that makes tire steering impossible has not occurred in step S2, steering control unit 31 calculates a target tire angle (σ*) from the steering angle detected by steering angle sensor 52 (step S8).

Next, steering control unit 31 drives wheel actuator 42 based on target tire angle (σ*) (step S9). Next, the process proceeds to END.

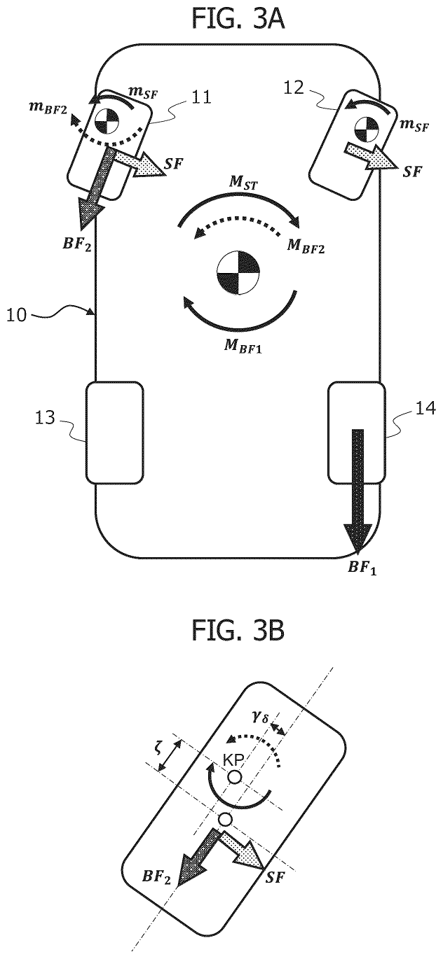

FIGS. 3A and 3B illustrate a vehicle motion and a tire motion based on driving and braking forces during a turn. The present example describes a vehicle motion and a tire motion when a scrub radius (γσ) of the front road wheels is negative (an individual kingpin axis KP is located on the outer side of its corresponding tire center). A moment (m_{BF2}) around a kingpin axis when a braking force (BF₂) is generated is expressed by the following Equation (1).

$$\begin{matrix}[ Equation 1 ] & \\ {m}_{BF 2} = {γ}_{δ} * B {F}_{2} & ( 1 )\end{matrix}$$

In addition, a moment (m_{SF}) around the kingpin axis when the tire angle is steered and a side force (SF) is generated is expressed by the following Equation (2) from the relationship with a caster trail (ζ)

$$\begin{matrix}[ Equation 2 ] & \\ {m}_{SF} = ζ * S F & ( 2 )\end{matrix}$$

From the above Equations (1) and (2), a tire angular acceleration (σ**) is expressed by the following Equation (3). A tire angle (σ) is calculated from double integration of Equation (3).

$$\begin{matrix}[ Equation 3 ] & \\ {σ}^{* *} = \frac{{m}_{BF 2} - 2 * {m}_{SF}}{{J}_{s}} & ( 3 )\end{matrix}$$

Side force (SF) is expressed by the following Equation (4) from the relationship among tire angle (σ) calculated from the above Equation (3), vehicle speed (V), a yaw rate (γ), a distance (l_{f}) from the center of gravity of the vehicle to the front axle, a sideslip angle (β) of the vehicle, and a cornering power (C_{f}) of the front road wheels.

$$\begin{matrix}[ Equation 4 ] & \\ S F = {F}_{yfl} = {F}_{yfr} = - {C}_{f} ( β + \frac{{l}_{f} γ}{V} - δ ) & ( 4 )\end{matrix}$$

A yaw moment (M_{C}) generated by braking forces (BF₁ and BF₂) and side force (SF) in the vehicle is expressed by the following Equation (5).

$$\begin{matrix}[ Equation 5 ] & \\ {M}_{c} = {M}_{B F 1} - {M}_{B F 2} + {M}_{S T} & ( 5 )\end{matrix}$$

As described above, a turn of vehicle 10 can be accomplished by controlling tire angle (σ) steered by braking force (BF₂) of the front road wheel in the above Equation (1), a vehicle yaw moment (M_{ST}) generated from side force (SF) generated from tire angle (σ), a yaw moment (M_{BF2}) generated by braking force (BF₂), and vehicle yaw moment (M_{BF1}) generated based on braking force (BF₁) of the rear road wheel.

Alternatively, during a turn, the slip amount of the tire (right rear road wheel 14) may be increased by using braking force (BF₁) of the rear road wheel, so as to reduce the side force of the tire (right rear road wheel 14). In addition, the balance between the front road wheels and the side force may be changed, so as to increase the yaw moment generated in the vehicle. In this way, the turn may be executed.

As described above, even when the steering function of the steer-by-wire system of a vehicle of which the scrub radius is negative malfunctions, by reducing the driving and braking forces applied to the outer road wheels to be less than the driving and braking forces applied to the inner road wheels (for example, by applying a larger force in the braking direction), it becomes possible to turn the vehicle in a direction desired by the driver.

In the case of road wheels in which a scrub radius is set, a moment is generated in a direction that steers the tires due to a braking force. In particular, in the case of road wheels in which the scrub radius is set to be negative, the tires are steered in a direction that cancels out the vehicle yaw moment generated by the braking force (a side force is generated by tire steering, and a vehicle yaw moment is generated). In particular, a vehicle that is greatly affected by the vehicle yaw moment due to steering may be steered in the direction opposite to the expected turning direction.

In the case of a vehicle having these characteristics, by reducing the total value of the driving and braking forces applied to the outer road wheels to be less than those applied to the inner road wheels, it becomes possible to accomplish a turn by using the side force generated by steering.

In the present invention, for the front road wheels, depending on the alignment characteristics, a driving and braking force difference for steering the tires is generated. For the rear road wheels, because the impact of the alignment characteristics is relatively small, a braking force difference for realizing a vehicle yaw moment is generated.

In this way, the turning function based on driving and braking forces can be accomplished, not only by generating a vehicle yaw moment by using the driving and braking force difference with inter-functional redundancy when the SbW malfunctions, but also by accomplishing a tire turning using the alignment characteristics.

Thus, with the vehicle control apparatus, the vehicle control method, and the vehicle control system as described above, the vehicle can be turned by using tire turning based on the braking force difference generated between the front road wheels and based on the alignment, and the vehicle can be turned by generating a vehicle yaw moment by using the braking force difference between the right and left rear road wheels. Thus, the turning function can be accomplished by using tire steering based on the braking force and the vehicle yaw moment.

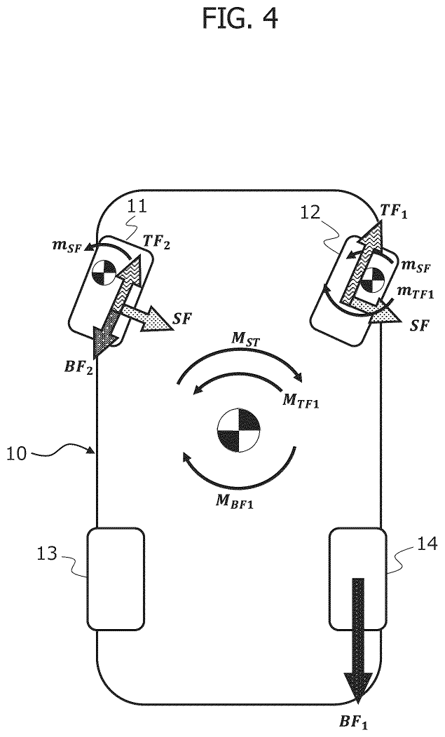

FIG. 4 illustrates a vehicle motion based on another control method using driving and braking forces. The scrub radius is also set to be negative in this vehicle 10. The moments about the kingpin axes of front road wheels 11 and 12 are generated by driving forces TF₂ and TF₁ and braking force BF₂. Specifically, a driving force difference is generated by causing motor 72 to generate a torque and by consequently driving brake actuator 15 of left front road wheel 11. In this way, front road wheels 11 and 12 are steered in the turning direction, and a vehicle yaw moment is generated by braking force BF₁ applied to right rear road wheel 14, whereby vehicle 10 is turned.

When the driving and braking forces are used, the driving and braking forces are allocated such that target longitudinal acceleration (αₓ*) is achieved. If target longitudinal acceleration (αₓ*) cannot be achieved, for example, the driving and braking forces of the individual road wheels are allocated such that the generated longitudinal acceleration drops to the deceleration side, so as to accomplish the necessary turn.

In addition, if the force that can be generated by an individual road wheel is saturated, for example, due to change in load, the driving and braking forces are allocated again such that another road wheel can generate force. For example, if in FIG. 4, braking force BF₁ that can be generated by right rear road wheel 14 is saturated, the driving and braking forces are allocated such that left rear road wheel 13 can generate a driving force.

Furthermore, if an individual road wheel detects a wheel slip of a predetermined value or greater, the driving and braking forces are allocated again such that the slip will not deteriorate.

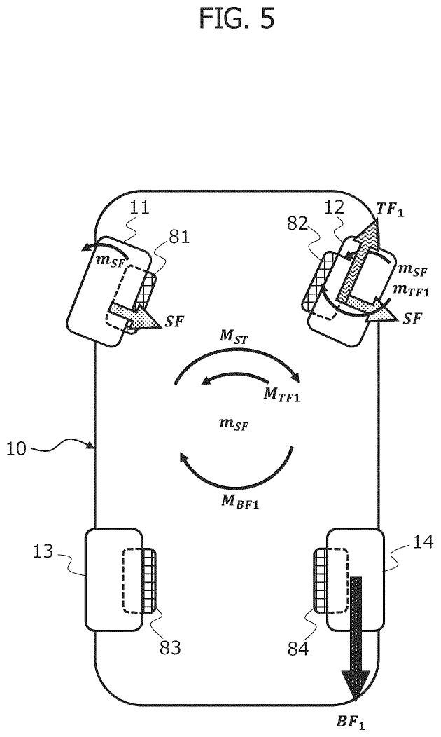

FIG. 5 illustrates yet another control method using driving and braking forces, that is, a vehicle motion when a driving force applied to an individual road wheel can be controlled. This example is applied to vehicle 10 having so-called in-wheel motors, which are motors 81, 82, 83, and 84 installed for their respective road wheels. In vehicle 10, the scrub radius is also set to be negative. Vehicle 10 uses motors 81 and 82. Specifically, motor 82 generates driving force TF₁ so as to generate a moment around the kingpin axis of right front road wheel 12. By generating a driving force difference in this way, front road wheels 11 and 12 are steered. In addition, vehicle 10 uses motors 83 and 84. Specifically, by using braking force BF₁ applied by brake actuator 18 of right rear road wheel 14, and the driving force applied by motor 83 of the left rear road wheel, a vehicle yaw moment is generated. As a result, vehicle 10 is turned.

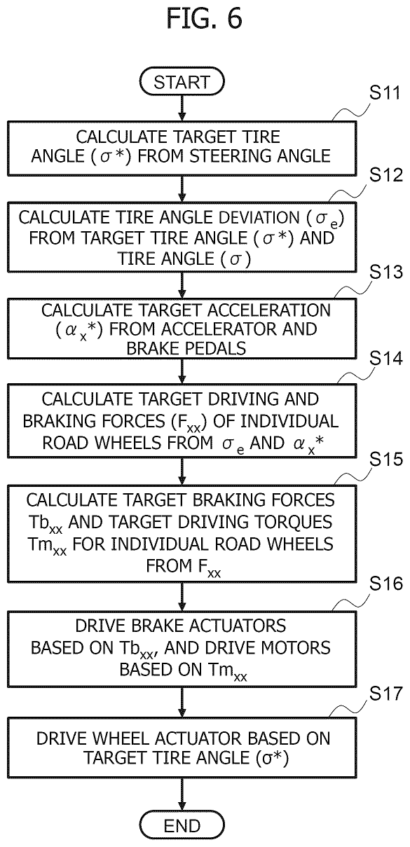

FIG. 6 illustrates a vehicle control apparatus, a vehicle control method, and a vehicle control system according to a second embodiment of the present invention, that is, a flowchart schematically illustrating a vehicle control method. In the present second embodiment, when the steer-by-wire system is normal, the tire angle is controlled, and the steering is assisted.

First, steering control unit 31 calculates target tire angle (σ*) from the steering angle detected by steering angle sensor 52 (step S11).

Next, steering control unit 31 calculates a tire angle deviation (σₑ) from the difference between target tire angle (σ*) and tire angle (σ) (step S12).

Next, brake control unit 32 detects the operation amount of brake pedal 61, powertrain control unit 33 detects the operation amount of accelerator pedal 71, and steering control unit 31 calculates target longitudinal acceleration (αₓ*) (step S13).

Next, steering control unit 31 calculates target driving and braking forces (F_{fl}, F_{fr}, Fᵣₗ, Fᵣᵣ) of the individual road wheels from tire angle deviation (σₑ) and target longitudinal acceleration (αₓ*) (step S14). Hereinafter, unless otherwise specified, the target driving and braking forces of the individual road wheels will be collectively referred to as “Fₓₓ”.

Next, steering control unit 31 calculates target braking forces (Tbₓₓ) generated by brake actuators 15, 16, 17, and 18, and calculates target driving torques (Tmₓₓ) generated by motors 72 and 73, from target driving and braking forces (Fₓₓ) of the individual road wheels (step S15).

Next, brake control unit 32 drives brake actuators 15, 16, 17, and 18 based on target braking forces (Tbₓₓ), and powertrain control unit 33 drives motors 72 and 73 based on target driving torques (Tmₓₓ) (step S16).

Next, steering control unit 31 drives wheel actuator 42 based on target tire angle (σ) (step S17).

According to the control method described above, it is possible to assist steering by controlling the tire angle. In addition, the steering assist according to the present second embodiment can also be applied to a steering apparatus (EPS) that is not based on a steer-by-wire (SbW) method, if the scrub radius of the steered road wheels is negative.

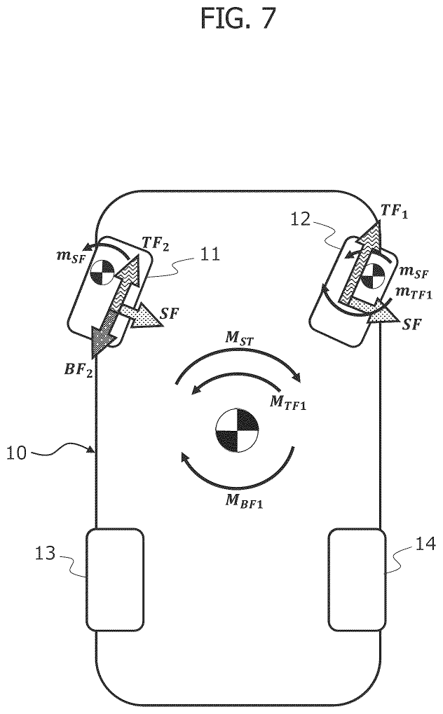

FIG. 7 illustrates a vehicle motion based on control using driving and braking forces in the vehicle control method illustrated in FIG. 6. To generate the moments around the kingpin axes of front road wheels 11 and 12, which are the steered road wheels, with driving forces TF₂ and TF₁ and braking force BF₂, a torque is generated by motor 72. By driving brake actuator 15 of left front road wheel 11, a driving force difference is generated, whereby steering of front road wheels 11 and 12 is assisted.

If the driving and braking forces are used, the driving and braking forces are allocated such that target longitudinal acceleration (αₓ*) is achieved. If target longitudinal acceleration (αₓ*) cannot be achieved, for example, a driving and braking force difference up to target longitudinal acceleration (αₓ*) is used to assist the tire steering.

According to the configurations and methods as described above, a vehicle is turned by using a braking force difference generated between the front road wheels and tire steering based on alignment, and the vehicle is turned by generating a vehicle yaw moment by using a braking force difference between the right and left rear road wheels. Thus, even when the SbW tire steering function malfunctions, a turn requested by the system can be accomplished by using the driving and braking forces, regardless of the alignment of the vehicle. In addition, by accomplishing the turning function based on the driving and braking forces regardless of the alignment characteristics, the SbW redundancy can be reduced, and cost can consequently be reduced. As a result, it is possible to obtain a vehicle control apparatus, a vehicle control method, and a vehicle control system that can accomplish a turning function using tire steering based on braking force and using a vehicle yaw moment.

The configurations, methods, etc., in the above-described first and second embodiments have been described only schematically to an extent that the present invention can be understood and implemented. Thus, the present invention is not limited to the above-described embodiments. The present invention can be modified to various modes, without departing from the scope of the technical concepts indicated by the claims.

For example, although steering control unit 31 calculates the target longitudinal acceleration in the above embodiments, another control unit in control unit 30 may calculate the target longitudinal acceleration. In addition, calculations executed by the individual control units 31, 32, and 33 in control unit 30 may, of course, be executed by another control unit. A dedicated control unit may be provided to accomplish the turning function in case the steering function malfunctions.

### REFERENCE SYMBOL LIST

10 Vehicle
11, 12 Front road wheel (tire)
13, 14 Rear road wheel (tire)
15, 16, 17, 18 Brake actuator
21, 22, 23, 24 Brake thrust sensor
30 Control unit
31 Steering control unit
32 Brake control unit
33 Powertrain control unit
41 Reaction force actuator
42 Wheel actuator
51 Steering wheel
52 Steering angle sensor
61 Brake pedal
71 Accelerator pedal
72, 73, 81, 82, 83, 84 Motor

1. A vehicle control apparatus provided in a vehicle having a steer-by-wire system for steering right and left steered road wheels which are mechanically separate from a steering wheel and of which a scrub radius is set to be negative,
wherein when a control unit included in the vehicle control apparatus acquires an abnormal signal of a steering function in the steer-by-wire system, the control unit outputs, based on a steering operation that is input to the steering wheel, a first driving and braking command, such that assuming that a driving force is a positive physical quantity and a braking force is a negative physical quantity, between the right and left steered road wheels, a total value of a driving force and a braking force applied to a turning outer steered road wheel of the vehicle becomes less than a total value of a driving force and a braking force applied to a turning inner steered road wheel of the vehicle.

2. The vehicle control apparatus according to claim 1, wherein the steered road wheels are front road wheels.

3. The vehicle control apparatus according to claim 2, wherein the control unit outputs, based on a steering operation that is input to the steering wheel, a second driving and braking command, such that assuming that a driving force is a positive physical quantity and a braking force is a negative physical quantity, between right and left rear road wheels, a total value of a driving force and a braking force applied to a turning inner rear road wheel of the vehicle becomes less than a total value of a driving force and a braking force applied to a turning outer rear road wheel of the vehicle.

4. The vehicle control apparatus according to claim 3, wherein based on a steering operation that is input to the steering wheel, the control unit outputs a slip control command for increasing, between the right and left rear road wheels, a slip amount of a turning inner rear road wheel of the vehicle.

5. The vehicle control apparatus according to claim 2, wherein the first driving and braking command is a command for applying a braking force to a turning outer front road wheel of the vehicle.

6. The vehicle control apparatus according to claim 2, wherein the first driving and braking command is a command for applying a driving force to a turning inner front road wheel of the vehicle.

7. The vehicle control apparatus according to claim 2, wherein the first driving and braking command is a command for applying a driving force and a braking force to a turning outer front road wheel of the vehicle and for applying a driving force to a turning inner front road wheel of the vehicle.

8. The vehicle control apparatus according to claim 3,
wherein the first driving and braking command is a command for applying a braking force to a turning outer front road wheel of the vehicle, and
wherein the second driving and braking command is a command for applying a driving force to a turning outer rear road wheel of the vehicle and for applying a braking force to a turning inner rear road wheel of the vehicle.

9. The vehicle control apparatus according to claim 3,
wherein the first driving and braking command is a command for applying a driving force to a turning inner front road wheel of the vehicle, and
wherein the second driving and braking command is a command for applying a driving force to a turning outer rear road wheel of the vehicle and for applying a braking force to a turning inner rear road wheel of the vehicle.

10. The vehicle control apparatus according to claim 3,
wherein the first driving and braking command is a command for applying a driving force and a braking force to a turning outer front road wheel of the vehicle and for applying a driving force to a turning inner front road wheel of the vehicle, and
wherein the second driving and braking command is a command for applying a driving force to a turning outer rear road wheel of the vehicle and for applying a braking force to a turning inner rear road wheel of the vehicle.

11. A vehicle control method executed by a control unit provided in a vehicle having a steer-by-wire system for steering right and left steered road wheels which are mechanically separate from a steering wheel and of which a scrub radius is set to be negative,
wherein when the control unit acquires an abnormal signal of a steering function in the steer-by-wire system, the control unit outputs, based on a steering operation that is input to the steering wheel, a first driving and braking command, such that assuming that a driving force is a positive physical quantity and a braking force is a negative physical quantity, between the right and left steered road wheels, a total value of a driving force and a braking force applied to a turning outer steered road wheel of the vehicle becomes less than a total value of a driving force and a braking force applied to a turning inner steered road wheel of the vehicle.

12. A vehicle control system comprising:
a steer-by-wire system for steering right and left steered road wheels which are mechanically separate from a steering wheel;
a control unit provided in a vehicle having the right and left steered road wheels of which a scrub radius is set to be negative; and
a drive and brake actuator that applies driving and braking forces to the right and left steered road wheels based on a first driving and braking command,
wherein when the control unit acquires an abnormal signal of a steering function in the steer-by-wire system, the control unit outputs, based on a steering operation that is input to the steering wheel, the first driving and braking command, such that assuming that a driving force is a positive physical quantity and a braking force is a negative physical quantity, between the right and left steered road wheels, a total value of a driving force and a braking force applied to a turning outer steered road wheel of the vehicle becomes less than a total value of a driving force and a braking force applied to a turning inner steered road wheel of the vehicle.

13. A vehicle control apparatus having a steer-by-wire system for steering right and left steered road wheels mechanically separate from a steering wheel,
wherein based on a steering operation that is input to the steering wheel and based on a setting of a scrub radius of the steered road wheels, a control unit included in the vehicle control apparatus calculates a driving and braking command, such that assuming that a driving force is a positive physical quantity and a braking force is a negative physical quantity, between the right and left steered road wheels, one of a total value of a driving force and a braking force applied to a turning outer steered road wheel of a vehicle and a total value of a driving force and a braking force applied to a turning inner steered road wheel of the vehicle becomes greater than the other, and outputs the calculated driving and braking command.
